(19) United States
(12) Patent Application Publication
(10) Pub. No.: US 2004/0087218 A1
(43) Pub. Date: May 6, 2004

(54) Method of fabricating a plug-in connector, and a plug-in connector

(76) Inventor: Roland Baumgaertner, Bonndorf (DE)

Correspondence Address: Samuels, Gauthier & Stevens LLP, Suite 3300, 225 Franklin Street, Boston, MA, 02110, US

(21) Appl. No.: 10/345,893

(22) Filed: Jan. 16, 2003

(30) Foreign Application Priority Data
Apr. 23, 2002 (DE) 102 18 002.4

(51) Int. Cl. H01R 13/10

(52) U.S. Cl. 439/682

(57) ABSTRACT

In order to be able simply and inexpensively to fabricate a plug-in connector consisting of a housing (1) and a spring basket (2) with longitudinal slots (3), the housing (1) and the spring basket (2) are fabricated from one piece by injection molding using the metal injection molding process. The longitudinal slots (3) are also formed at the time of injection molding.

### BACKGROUND OF THE INVENTION

The invention relates to the field of connector assemblies, and in particular to a plug-in connector of a single piece unitary construction with a housing and a spring basket.

Known plug-in connectors include a sleeve-type housing with a lateral connection branch and, a sleeve-type spring basket, which is plugged into the sleeve-type housing.

The procedure for fabricating these connectors is relatively complex since the connector consists of two parts that must be plugged together. An additional factor that increases the fabrication complexity is that the spring basket is a stamped part while the housing is made by milling or turning a blank.

Therefore, there is a need for a technique of fabricating a plug-in connector that is relatively simple and inexpensive.

### SUMMARY OF THE INVENTION

A plug-in connector component comprises a housing that forms a first longitudinal chamber and a second longitudinal chamber. The first longitudinal chamber includes a first interior surface having a distal open longitudinal end. The first longitudinal chamber is adjacent and open to the second longitudinal chamber that includes a second interior surface, which provides a proximate open longitudinal end. The second interior surface includes at least one longitudinal slot and the plug-in connector component is of a single piece unitary construction.

The plug-in connector is fabricated by injection molding in one piece. The injection molding is by the metal injection molding (MIM) process in which a mixture of metal powder and a binder are injected, as in plastic injection molding, into a mold. After injection, the binder components are removed from the mixture in a so-called debinding process such that only metal powder and residual binder remain. In the next step of the process, a sintering process, the metal powder is “baked together” at high temperature and high pressure to attain its proper density and strength. At the end of the process, a dimensionally correct metal workpiece remains.

The plug-in connector is thus produced as a single piece, in contrast to the prior art that includes two plug-together pieces, of which one is fabricated by stamping and the other, by milling or turning.

One embodiment of the invention has at least one longitudinal slot in the spring basket, the shape of which is preferably already incorporated into the injection mold.

Another embodiment has a connection branch projecting laterally from the housing. Alternatively, the connection branch may project in an axial direction from the housing. The housing and connection branch, as well as the spring basket, are fabricated in one piece by injection molding.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a cross-sectional view of one embodiment of a plug-in connector according to the invention; and

FIG. 2 is a cross-sectional view of a prior art plug-in connector.

### DETAILED DESCRIPTION OF THE INVENTION

FIG. 2 shows a section of a plug-in connector according to the prior art.

A sleeve-type spring basket 2 with multiple longitudinal slots 3 is plugged into a housing 1 including a laterally projecting connection branch 4. The spring basket 2 is designed as a stamped part, while the housing 1 is a milled and turned part.

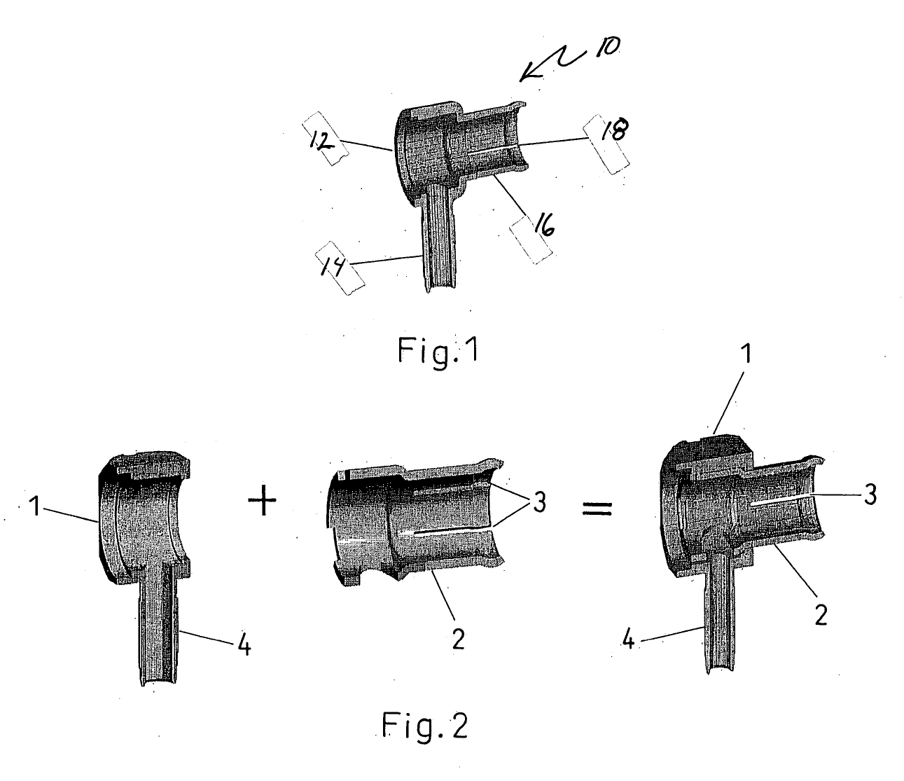

FIG. 1 is a cross-sectional view of one embodiment of a plug-in connector 10 according to the invention.

The embodiment illustrated in FIG. 1 includes a housing 12 with a laterally projecting connection branch 14 and a spring basket 16 with multiple longitudinal slots 18. The difference between the known connector illustrated in FIG. 2 and the inventive connector 10 illustrated in FIG. 1 is that the plug-in connector 10 is fabricated in one piece by injection molding. After injection molding, the plug-in connector 10 preferably undergoes debinding and sintering.

Fabrication of the plug-in connector 10 is relatively simple and inexpensive since the plug-in connector is fabricated as one piece, and therefore does not have to be plugged together from two individual pieces. In addition, the spring basket 16 no longer needs to be fabricated as a stamped part, as was previously the case. The housing 12 no longer needs to be milled and turned from a blank. Only injection molding according to the MIM process is required to fabricate a plug-in connector according to the invention.

Although the present invention has been shown and described with respect to several preferred embodiments thereof, various changes, omissions and additions to the form and detail thereof, may be made therein, without departing from the spirit and scope of the invention.

The invention relates to a method of fabricating a plug-in connector with a housing and a spring basket.

The invention further relates to a plug-in connector with a housing and a spring basket.

Plug-in connectors are known which consist of a sleeve-type housing with a lateral connection branch and a sleeve-type spring basket, the spring basket being plugged into the sleeve-type housing.

The procedure for fabricating these connectors is relatively complex since the connector consists of two parts that must be plugged-together, and since the spring basket is a stamped part while the housing is made by milling or turning a blank.

The goal of the invention is therefore to design both a method of fabricating a plug-in connector, and a plug-in connector, whereby the fabrication process is both simple and inexpensive.

In terms of method, this goal is achieved according to the characteristic features listed in claim 1 by fabricating the housing and the spring basket out of a single piece by injection molding, according to the metal injection molding process or MIM.

In terms of the device, this goal is achieved according to the characteristic features listed in claim 6 by fabricating the housing and the spring basket out of a single piece by injection molding, according to the metal injection molding process or MIM.

In the method according to the invention, the plug-in connector according to the invention is fabricated by injection molding in one piece. The injection molding is by the metal injection molding process in which a mixture of metal powder and a binder are injected, as in plastic injection molding, into a mold. After injection, the binder components are removed from the mixture in a so-called debinding process so that only metal powder and residual binder remain. In the next step of the process, a sintering process, the metal powder is “baked together” at high temperature and high pressure to attain its proper density and strength. At the end of the process, a dimensionally correct metal workpiece remains.

The plug-in connector according to the invention is thus-produced as a single piece; it no longer consists of two plug-together pieces, of which one is fabricated by stamping and the other, by milling or turning.

One embodiment of the invention has at least one longitudinal slot in the spring basket, the shape of which is preferably already incorporated into the injection mold.

Another embodiment has a connection branch projecting laterally from the housing. Alternatively, the connection branch may project in an axial direction from the housing. The housing and connection branch, as well as the spring-basket, are fabricated in one piece by injection molding.

The invention will now be described and explained in more detail based on the figures.

FIG. 1 is a cross-sectional view of one embodiment of the plug-in connector according to the invention, and

FIG. 2 is a cross-sectional view of a plug-in connector according to the prior art.

FIG. 2 shows a section of a plug-in connector according to the prior art.

A sleeve-type spring basket 2 with multiple longitudinal slots 3 is plugged into a housing 1 including a laterally projecting connection branch 4. Spring basket 2 is designed as a stamped part, while the housing is a milled and turned part.

FIG. 1 is a cross-sectional view of one embodiment of the plug-in connector according to the invention.

As with the known plug-in connector shown in FIG. 2, the embodiment according to the invention consists of a housing 1 with a laterally projecting connection branch 4 and a spring basket 2 with multiple longitudinal slots 3, the difference being that the plug-in connector according to the invention is fabricated in one piece by injection molding. After injection molding, the plug-in connector preferably undergoes debinding and sintering.

Fabrication of a plug-in connector according to the invention is especially simple and inexpensive since the plug-in connector is fabricated as one piece, and therefore does not have to be plugged together from two individual pieces. In addition, the spring basket no longer needs to be fabricated as a stamped part, as was previously the case. The housing no longer needs to be milled and turned from a blank. Only injection molding according to the MIM process is required to fabricate a plug-in connector according to the invention.

List of Reference Numerals

| | |
|---|---|
| 1 | Housing |
| 2 | Spring basket |
| 3 | Longitudinal slot |
| 4 | Connection branch |

1. Method of fabricating a plug-in connector with a housing (1) and a spring basket (2), characterized in that the housing (1) and the spring basket (2) are fabricated from one piece by injection molding using the injection molding process, or MIM.

2. Method according to claim 1, characterized in that at least one longitudinal slot (3) is provided in the spring basket (2).

3. Method according to claim 2, characterized in that the shape of the longitudinal slot, or of the longitudinal slots, is provided in the injection mold.

4. Method according to claims 1, 2, or 3, characterized in that a connection branch (4) projects laterally from the housing (1), and that the housing (1), the spring basket (2) and the connection branch (4) are fabricated in one piece by injection molding using the MIM process.

5. Method according to claims 1 through 4, characterized in that the plug-in connector undergoes debinding and sintering after injection molding.

6. Plug-in connector with a housing (1) and with a spring basket (2), characterized in that the housing (1) and the spring basket (2) are fabricated in one piece by injection molding using the metal injection molding process or MIM.

7. Plug-in connector according to claim 6, characterized in that at least one longitudinal slot (3) is provided in the spring basket (2).

8. Plug-in connector according to claims 6 or 7, characterized in that a connection branch (4) projects laterally from the housing (1), and that the housing (1), the spring basket (2) and the connection branch (4) are fabricated in one piece by injection molding using the MIM process.

9. Plug-in connector according to claims 6, 7, or 8, characterized in that the density and strength of the connector is enhanced by sintering.
